(19) United States
(12) Patent Application Publication
(10) Pub. No.: US 2025/0367848 A1
(43) Pub. Date: Dec. 4, 2025

(54) CHAINSAW

(71) Applicant: Nanjing Chervon Industry Co., Ltd., Nanjing (CN)

(72) Inventors: Haishen Xu, Nanjing (CN); Liang Chen, Nanjing (CN); Chenglong Hu, Nanjing (CN); Da Li, Nanjing (CN); Yong Wang, Nanjing (CN); Xiangqing Fu, Nanjing (CN)

(21) Appl. No.: 19/306,573

(22) Filed: Aug. 21, 2025

Related U.S. Application Data
(63) Continuation of application No. PCT/CN2024/087138, filed on Apr. 11, 2024.

(30) Foreign Application Priority Data
Apr. 21, 2023 (CN) 202310436316.4

(51) Int. Cl. B27B 17/08; B27B 17/00; B27B 17/02; B27B 17/12

(52) U.S. Cl. CPC B27B 17/083; B27B 17/0008; B27B 17/02; B27B 17/12

(57) ABSTRACT

A chainsaw includes a tool body and a power supply device, where the power supply device is configured to provide a power source for the tool body. The tool body includes: a housing; a chain configured to perform a cutting function; a guide plate for supporting and guiding the chain; a drive device, where the drive device is at least partially disposed in an accommodating space formed by the housing and includes a motor configured to drive the chain; and a brake device configured to brake the drive device. The tool body includes a main machine. The main machine includes at least the housing, the drive device, and the brake device. The motor is an outrunner. The power-to-mass density of the main machine is greater than or equal to 0.5 kW/kg and less than or equal to 2.0 kW/kg.

### RELATED APPLICATION INFORMATION

This application is a continuation of International Application Number PCT/CN2024/087138, filed on Apr. 11, 2024, through which this application also claims the benefit under 35 U.S.C. § 119(a) of Chinese Patent Application No. CN 202310436316.4, filed on Apr. 21, 2023, which applications are incorporated herein by reference in their entireties.

### BACKGROUND

As a garden power tool, a chainsaw is widely used in households, gardens, and other fields. A chainsaw is a garden tool that uses a power device to drive the staggered L-shaped blades on the chainsaw to move horizontally to cut wood or branches. For a chainsaw in the related art, the cutting efficiency of the chainsaw depends greatly on the output power of the chainsaw. However, high output power usually requires the chainsaw to have a relatively large volume and a relatively heavy weight. A chainsaw with a relatively large volume is not easy for a user to hold, and a chainsaw with a relatively heavy weight is not conducive to long-time use by the user.

This part provides background information related to the present application, and the background information is not necessarily the existing art.

### SUMMARY

A chainsaw includes a tool body and a power supply device, where the power supply device is configured to provide a power source for the tool body, and the tool body includes: a housing; a chain configured to perform a cutting function; a guide plate for supporting and guiding the chain; a drive device, where the drive device is at least partially disposed in an accommodating space formed by the housing and includes a motor configured to drive the chain; and a brake device configured to brake the drive device. The tool body includes a main machine, the main machine does not include the chain and the guide plate, the main machine includes at least the housing, the drive device, and the brake device, and the ratio of the output power of the main machine to the mass of the main machine is higher than or equal to 0.5 kW/kg and lower than or equal to 2.0 kW/kg.

In some examples, the main machine is configured as follows: the power of the motor is 4 kW, and the mass of the main machine is greater than or equal to 3.0 kg and less than or equal to 3.5 kg, or the power of the motor is 5 kW, and the mass of the main machine is greater than or equal to 3.5 kg and less than or equal to 4.0 kg, or the power of the motor is 6 kW, and the mass of the main machine is greater than or equal to 3.9 kg and less than or equal to 4.5 kg.

In some examples, the main machine is configured as follows: the power of the motor is 4 kW, and the mass of the main machine is greater than or equal to 3.2 kg and less than or equal to 3.5 kg, or the power of the motor is 5 kW, and the mass of the main machine is greater than or equal to 3.6 kg and less than or equal to 3.85 kg, or the power of the motor is 6 kW, and the mass of the main machine is greater than or equal to 3.9 kg and less than or equal to 4.2 kg.

In some examples, the output power of the motor is greater than or equal to 4000 W.

In some examples, a rotational speed of the motor is greater than or equal to 5000 rpm and less than or equal to 20000 rpm.

In some examples, the rated linear speed of the chain is greater than or equal to 10 m/s and less than or equal to 70 m/s.

In some examples, the nominal voltage of the power supply device is greater than or equal to 25 V and less than or equal to 150 V.

In some examples, the power supply device includes at least one battery pack.

In some examples, the power supply device includes battery packs with different nominal voltages.

In some examples, the housing includes a handle portion configured to be held by a user and a body portion at least configured to accommodate the drive device and part of the brake device, where the plane on which the guide plate is located is used as a cutting plane, and in a projection plane perpendicular to the cutting plane, the center of gravity of an orthographic projection of the main machine is within an orthographic projection of the body portion.

In some examples, the housing includes at least one coupling portion configured to be electrically connected to a battery pack.

In some examples, the main machine further includes a lubrication device including an oil pump capable of pumping lubricant to the guide plate or the chain, where when the motor rotates, the oil pump is capable of being driven by a rotating drum of the rotating motor to work.

In some examples, the ratio of the output power of the motor to the mass of the motor is higher than or equal to 1 kW/kg and lower than or equal to 5 kW/kg.

In some examples, the drive device is disposed in the accommodating space formed by the housing, and the brake device is configured to brake the motor.

In some examples, the brake device includes a mechanical brake module capable of mechanically braking the motor through friction and an electronic brake module capable of causing the motor to stop rotating or reduce a rotational speed, where the brake device is configured to: activate the mechanical brake module after the electronic brake module is activated, or activate the mechanical brake module while the electronic brake module is activated, or activate the electronic brake module after the mechanical brake module is activated.

In some examples, the motor includes the rotating drum, and the rotating drum is capable of being configured to cooperate with the brake device to implement mechanical braking.

In some examples, the brake device includes a brake belt surrounding the rotating drum along the radial direction of the motor, and the brake belt is configured to be capable of performing contraction motion on the surface of the rotating drum along the radial direction of the motor to mechanically brake the motor.

In some examples, the brake device and the rotating drum adopt shoe braking or caliper braking.

In some examples, the motor is a brushless motor, and the motor is an outrunner.

In some examples, the outer diameter of the outrunner is greater than or equal to 30 millimeters and less than or equal to 200 millimeters.

A chainsaw includes a tool body and a power supply device, where the power supply device is configured to provide a power source for the tool body, and the tool body includes: a housing; a chain configured to perform a cutting function; a guide plate for supporting and guiding the chain; a drive device, where the drive device is at least partially disposed in an accommodating space formed by the housing and includes a motor configured to drive the chain, and the motor is rotatable about a first straight line; and a brake device configured to brake the motor. The motor is an outrunner, and the motor includes a rotating drum and the rotating drum is capable of being configured to cooperate with the brake device to implement mechanical braking.

In some examples, the brake device includes a brake belt surrounding the rotating drum along the radial direction of the motor, and the brake belt is configured to be capable of performing contraction motion on the surface of the rotating drum along the radial direction of the motor to mechanically brake the motor.

In some examples, a wrap angle formed between the brake belt and the rotating drum when the mechanical braking is implemented is greater than or equal to 10° and less than or equal to 360°.

In some examples, the rotating drum includes a brake portion and is configured to cooperate with the brake device to implement the mechanical braking.

In some examples, the Rockwell hardness difference between the brake belt and the brake portion is at most 10 HRC.

In some examples, the motor further includes a mounting base configured to be mounted with the rotating drum, where the brake portion is located at an end of the rotating drum close to or far from the mounting base.

In some examples, the motor further includes: a rotor configured to output the torque of the motor, where the rotor includes the rotating drum and an output shaft; and a stator core disposed in the rotating drum and used for winding a winding coil; where along the direction of the first straight line, a minimum distance between the brake portion and a fixing end of the rotor is less than or equal to half of the length of the stator core.

In some examples, the brake device further includes: a rotary shaft fixed in the accommodating space of the housing, where a second straight line is used as the central axis of the rotary shaft; a brake trigger configured to be pulled by a user to activate a braking function, where the brake trigger is rotatable about the second straight line; and an elastic member disposed in the accommodating space of the housing; where when rotating, the brake trigger is capable of causing the elastic member to elongate or shorten, and telescopic motion of the elastic member is capable of driving the brake belt to perform expansion motion or contraction motion on the surface of the rotating drum along the radial direction of the motor.

In some examples, an end of the brake trigger protrudes from the accommodating space of the housing.

In some examples, in a plane perpendicular to the second straight line, the tangent line at the highest point of a circular projection of the motor in an up and down direction is a third straight line, the tangent line at the lowest point of the circular projection of the motor in the up and down direction is a fourth straight line, and a projection of the second straight line is between the third straight line and the fourth straight line.

In some examples, the brake device includes a mechanical brake module capable of mechanically braking the motor through friction and an electronic brake module capable of causing the motor to stop rotating or reduce the rotational speed, where the brake device is configured to: activate the mechanical brake module after the electronic brake module is activated, or activate the mechanical brake module while the electronic brake module is activated, or activate the electronic brake module after the mechanical brake module is activated.

In some examples, the electronic brake module includes a controller and is capable of causing the motor to stop rotating or reducing the rotational speed, where the controller is configured to control the motor to reduce the rotational speed or stop rotating in the case where the user pulls the brake trigger.

In some examples, the brake device is configured as follows: in the case where the user pulls the brake trigger, the controller first controls the motor to reduce the rotational speed or stop rotating, and then the brake belt performs the contraction motion on the surface of the rotating drum; or in the case where the user pulls the brake trigger, the brake belt first performs the contraction motion on the surface of the rotating drum, and then the controller controls the motor to reduce the rotational speed or stop rotating; or in the case where the user pulls the brake trigger, the brake belt performs the contraction motion on the surface of the rotating drum while the controller controls the motor to reduce the rotational speed or stop rotating.

In some examples, the nominal voltage of the power supply device is greater than or equal to 25 V and less than or equal to 150 V.

In some examples, the housing includes at least one coupling portion configured to be electrically connected to a battery pack.

In some examples, an output rotational speed of the motor is greater than or equal to 7000 rpm.

A chainsaw includes a tool body and a power supply device, where the power supply device is configured to provide a power source for the tool body, and the tool body includes: a housing; a chain configured to perform a cutting function; a guide plate for supporting and guiding the chain; a drive device, where the drive device is at least partially disposed in an accommodating space formed by the housing and includes a motor configured to drive the chain; a brake device configured to brake the drive device; and a lubrication device including an oil pump capable of pumping lubricant to the guide plate or the chain, where when the motor rotates, the oil pump is capable of being driven by a rotating drum of the rotating motor.

In some examples, a transmission mode between the oil pump and the rotating drum is one or a combination of gear transmission, cam transmission, or crank-link transmission.

In some examples, the lubrication device includes: an oil can configured to store the lubricant; the oil pump configured to deliver the lubricant from the oil can to the guide plate or the chain; a drive gear communicating with the oil pump, where the drive gear is configured to be capable of driving, during rotation, the oil pump to absorb and discharge the lubricant; and a gear sleeve sleeved around the rotating drum of the motor along the radial direction of the motor, where the gear sleeve is capable of meshing with the drive gear; where the lubrication device is configured as follows: in the case where the motor rotates, the rotating drum drives the gear sleeve to rotate, and the gear sleeve drives the drive gear to rotate and thus drives the oil pump to absorb and discharge the lubricant.

In some examples, the capacity of the oil can is greater than or equal to 100 milliliters and less than or equal to 600 milliliters.

In some examples, the volume of the oil can is less than or equal to the volume of the motor.

In some examples, the volume of the oil can is greater than the volume of the motor and less than or equal to 2.5 times the volume of the motor.

In some examples, the motor is a brushless motor, and the motor is an outrunner.

In some examples, the outer diameter of the outrunner is greater than or equal to 30 millimeters and less than or equal to 200 millimeters.

In some examples, the outer diameter of the outrunner may be 30 millimeters, 65 millimeters, 90 millimeters, or 105 millimeters.

In some examples, the motor further includes: a rotor configured to output the torque of the motor, where the rotor includes the rotating drum and an output shaft; and a stator core at least partially disposed in the rotating drum and used for winding a winding coil.

In some examples, the oil pump supplies oil continuously or intermittently.

In some examples, the oil pump is configured to adopt a combined oil supply mode of continuous oil supply and intermittent oil supply.

In some examples, the oil pump is capable of pumping the lubricant to the guide plate or the chain.

In some examples, the drive device is disposed in the accommodating space formed by the housing, and the brake device is configured to brake the motor.

In some examples, the ratio of the output power of the motor to the mass of the motor is higher than or equal to 1 kW/kg and lower than or equal to 5 kW/kg.

A chainsaw includes a tool body and a power supply device, where the power supply device is configured to provide a power source for the tool body, and the tool body includes: a housing; a chain configured to perform a cutting function; a guide plate for supporting and guiding the chain; a drive device, where the drive device is at least partially disposed in an accommodating space formed by the housing and includes a motor configured to drive the chain, and the motor is rotatable about a first straight line; and a brake device configured to brake the drive device. The brake device includes a brake trigger configured to be pulled by a user to activate a braking function, and the brake trigger is rotatable about a second straight line. In a plane perpendicular to the second straight line, the tangent line at the highest point of a circular projection of the motor in an up and down direction is a third straight line, the tangent line at the lowest point of the circular projection of the motor in the up and down direction is a fourth straight line, and a projection of the second straight line is between the third straight line and the fourth straight line.

In some examples, an end of the brake trigger protrudes from the accommodating space of the housing.

In some examples, in the plane perpendicular to the second straight line, the diameter of the circular projection of the motor is L1, where 30 millimeters≤L1≤200 millimeters.

In some examples, in the plane perpendicular to the second straight line, the distance between the projection of the second straight line and the center of the circular projection of the motor is L2, where the ratio of L1 to L2 is higher than or equal to 0.25 and lower than or equal to 2.

In some examples, in the plane perpendicular to the second straight line, the minimum distance between the projection of the second straight line and the fourth straight line is L3, where L3 is greater than or equal to half of L1 and less than or equal to L1.

In some examples, the housing includes a handle portion configured to be held by the user and a body portion at least configured to accommodate the drive device and part of the brake device, where the plane on which the guide plate is located is used as a cutting plane, and in a projection plane perpendicular to the cutting plane, the center of gravity of an orthographic projection of the tool body is within an orthographic projection of the body portion.

In some examples, the motor is an outrunner, and the outer diameter of the outrunner may be 30 millimeters, 65 millimeters, 90 millimeters, or 105 millimeters.

In some examples, a rotational speed of the motor is greater than or equal to 5000 rpm and less than or equal to 20000 rpm.

In some examples, the rated linear speed of the chain is greater than or equal to 10 m/s and less than or equal to 70 m/s.

In some examples, the nominal voltage of the power supply device is greater than or equal to 25 V and less than or equal to 150 V.

A chainsaw includes a tool body and a power supply device, where the power supply device is configured to provide a power source for the tool body, and the tool body includes: a housing; a chain configured to perform a cutting function; a guide plate for supporting and guiding the chain; and a drive device, where the drive device is at least partially disposed in an accommodating space formed by the housing and includes a motor configured to drive the chain. The motor includes a rotating drum and a mounting base disposed at an end of the rotating drum. The drive device further includes a circuit board capable of at least controlling the start and stop of the motor, and the circuit board is mounted on the mounting base of the motor.

In some examples, the mounting base includes an aluminum alloy material.

In some examples, the motor is a brushless motor, and the motor is an outrunner.

In some examples, the circuit board includes a power module mounted on the mounting base.

In some examples, the mounting base includes a mounting groove, and the power module is mounted in the mounting groove.

In some examples, the circuit board is in interference fit with the mounting groove.

In some examples, the circuit board is adhered to the mounting base, or the circuit board is fixed to the mounting base through a screw.

In some examples, the motor further includes: a rotor configured to output the torque of the motor, where the rotor includes the rotating drum and an output shaft; and a stator core at least partially disposed in the rotating drum and used for winding a winding coil.

In some examples, the tool body further includes a temperature sensor capable of monitoring a temperature of the circuit board and/or a temperature of the motor, and the circuit board is configured to control the motor to stop rotating when the temperature sensor detects that the temperature of the circuit board or the temperature of the motor exceeds a preset temperature threshold.

In some examples, the drive device is disposed in the accommodating space formed by the housing.

A chainsaw includes a tool body and a power supply device, where the power supply device is configured to provide a power source for the tool body, and the tool body includes: a housing; a chain configured to perform a cutting function; a guide plate for supporting and guiding the chain; and a drive device, where the drive device is at least partially disposed in an accommodating space formed by the housing and includes a motor configured to drive the chain. The motor includes an output shaft configured to output the torque of the motor and a rotating drum capable of accommodating part of the output shaft. The drive device further includes a fan disposed at an end of the output shaft extending out of the rotating drum to output the torque, the fan is disposed between the guide plate and the rotating drum, and an airflow generated by the rotating fan is capable of passing the guide plate and/or the chain.

In some examples, an air outlet of the housing is oriented toward or close to part of the guide plate and/or part of the chains.

In some examples, the drive device includes a circuit board, the circuit board is separated from the motor, and an air inlet of the housing is oriented toward or close to part of the circuit board.

In some examples, the circuit board includes a power module, and the air inlet is oriented toward or close to the power module of the circuit board.

In some examples, the motor further includes a mounting base configured to be mounted with the rotating drum.

In some examples, the rotating drum is located between the mounting base and the fan, or the mounting base is located between the rotating drum and the fan.

In some examples, the air inlet of the housing is oriented toward or close to part of the mounting base.

In some examples, the circuit board is mounted at an end of the mounting base that is oriented toward or close to the air inlet.

In some examples, the power module of the circuit board is mounted at the end of the mounting base that is oriented toward or close to the air inlet.

In some examples, the mounting base includes an aluminum alloy material.

In some examples, the housing includes a debris accumulation region, and an airflow generated by the rotating fan is capable of passing the debris accumulation region.

In some examples, the airflow generated by the rotating fan is capable of passing through the inside of the motor.

In some examples, the motor is an outrunner and includes the rotating drum that can be configured to cooperate with a brake device to implement mechanical braking, and the rotating drum includes a brake portion configured to cooperate with the brake device to implement the mechanical braking, where the airflow generated by the rotating fan is capable of passing the brake portion.

A chainsaw includes a tool body and a power supply device, where the power supply device is configured to provide a power source for the tool body, and the tool body includes: a housing; a chain configured to perform a cutting function; a guide plate for supporting and guiding the chain; a drive device, where the drive device is at least partially disposed in an accommodating space formed by the housing and includes a motor configured to drive the chain; and a brake device configured to brake the drive device. The output power of the motor is greater than or equal to 4000 W.

In some examples, the tool body includes a main machine, the main machine does not include the chain and the guide plate, and the main machine includes at least the housing, the drive device, and the brake device. In some examples, the main machine is configured as follows: the power of the motor is 4 kW, and the mass of the main machine is greater than or equal to 3.0 kg and less than or equal to 3.5 kg, or the power of the motor is 5 kW, and the mass of the main machine is greater than or equal to 3.5 kg and less than or equal to 4.0 kg, or the power of the motor is 6 kW, and the mass of the main machine is greater than or equal to 3.9 kg and less than or equal to 4.5 kg.

In some examples, the ratio of the output power of the motor to the mass of the motor is higher than or equal to 1 kW/kg and lower than or equal to 5 kW/kg.

In some examples, the ratio of the output power of the drive device to the mass of the drive device is higher than or equal to 2.5 kW/kg and lower than or equal to 3.5 kW/kg.

In some examples, the motor is a brushless motor, and the motor is an outrunner, where the outer diameter of the outrunner is greater than or equal to 30 millimeters and less than or equal to 200 millimeters.

In some examples, the nominal voltage of the power supply device is greater than or equal to 25 V and less than or equal to 150 V.

In some examples, the tool body further includes a lubrication device including an oil pump capable of pumping lubricant to the guide plate or the chain, where when the motor rotates, the oil pump is capable of being driven by the rotating drum of the rotating motor to work.

In some examples, the brake device includes a mechanical brake module capable of mechanically braking the motor through friction and an electronic brake module capable of causing the motor to stop rotating or reduce a rotational speed, where the brake device is configured to: activate the mechanical brake module after the electronic brake module is activated, or activate the mechanical brake module while the electronic brake module is activated, or activate the electronic brake module after the mechanical brake module is activated.

In some examples, the motor includes the rotating drum, and the rotating drum is capable of being configured to cooperate with the brake device to implement mechanical braking, and the brake device includes a brake belt surrounding the rotating drum along the radial direction of the motor, and the brake belt is configured to be capable of performing contraction motion on the surface of the rotating drum along the radial direction of the motor to mechanically brake the motor.

In some examples, the motor includes a rotating drum and a mounting base mounted at an end of the rotating drum, where the drive device further includes a circuit board capable of controlling at least the start and stop of the motor, and the circuit board is mounted on the mounting base.

### BRIEF DESCRIPTION OF THE DRAWINGS

FIG. 1 is a perspective view of a chainsaw according to an example of the present application.

FIG. 2 is an exploded view of a tool body according to an example of the present application.

FIG. 3 is an exploded view of a tool body with a housing removed according to an example of the present application.

FIG. 4 is a plan view showing part of the structure of a tool body according to an example of the present application.

FIG. 5 is a plan view of a brake device according to an example of the present application.

FIG. 6 is a perspective view of a drive device and a lubrication device from a viewing angle according to an example of the present application.

FIG. 7 is a perspective view of a drive device and a lubrication device from a viewing angle according to an example of the present application.

FIG. 8 is a perspective view of a tool body according to an example of the present application.

FIG. 9 is a plan view of a tool body with part of a housing removed according to an example of the present application.

FIG. 10 is an exploded view of a tool body according to an example of the present application.

FIG. 11 is a perspective view of a drive device, a brake device, and a lubrication device from a viewing angle according to an example of the present application.

FIG. 12 is a perspective view of a drive device and a brake device from a viewing angle according to an example of the present application.

FIG. 13 is a perspective view of a brake device according to an example of the present application.

FIG. 14 is a perspective view of a drive device and a lubrication device from a viewing angle according to an example of the present application.

FIG. 15 is a perspective view of some structures of a lubrication device according to an example of the present application.

FIG. 16 is a plan view of part of a drive device and a brake device according to an example of the present application.

FIG. 17 is a perspective view of a tool body from a viewing angle according to an example of the present application.

FIG. 18 is a plan view of a brake trigger and a housing according to an example of the present application.

FIG. 19 is a perspective view of a drive device according to an example of the present application.

FIG. 20 is an exploded view of the drive device in FIG. 19.

FIG. 21 is a sectional view showing part of the structure of a drive device according to an example of the present application.

FIG. 22 is a schematic block diagram showing part of the structure of a tool body according to an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

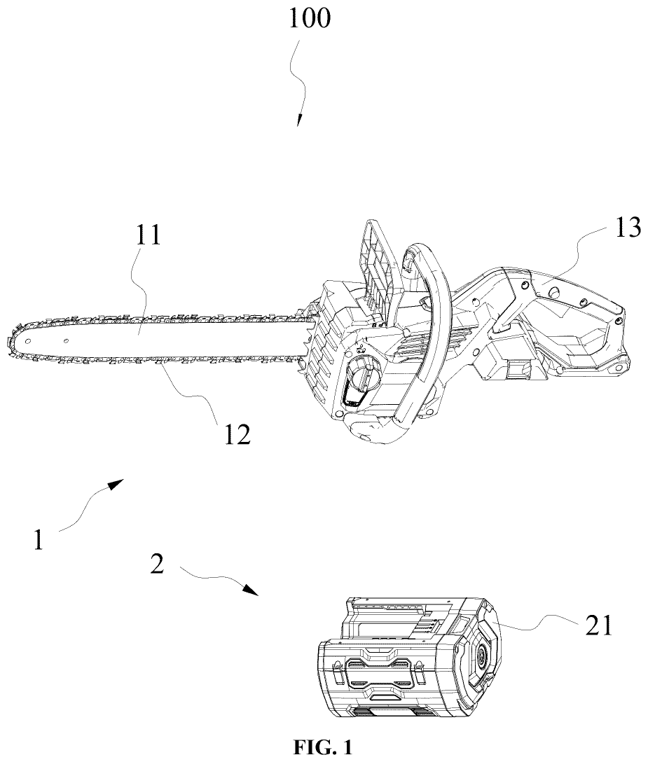

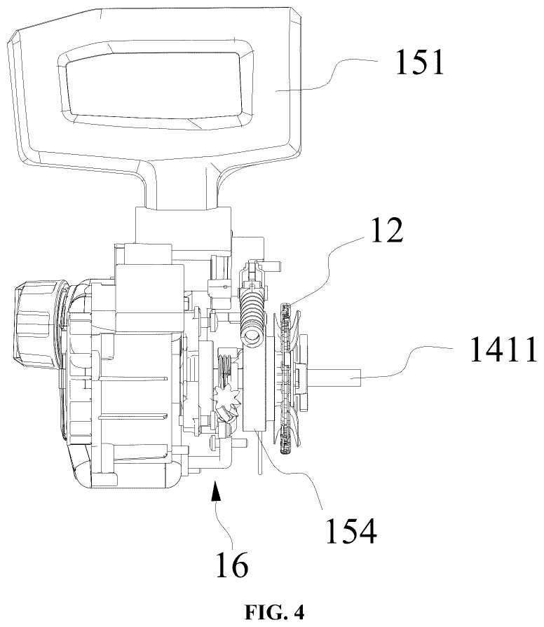

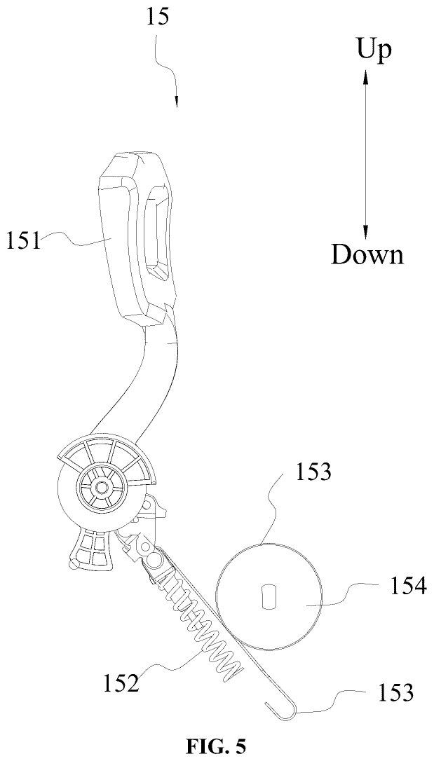

As shown in FIGS. 1 to 7, the present application provides a chainsaw 100. The chainsaw 100 includes a tool body 1 and a power supply device 2 that is configured to provide a power source for the tool body 1. The power supply device 2 includes at least one battery pack 21. The battery pack 21 is detachably connected to the tool body 1 so that it is convenient for a user to replace the battery pack 21 and the service time of the chainsaw 100 is prolonged.

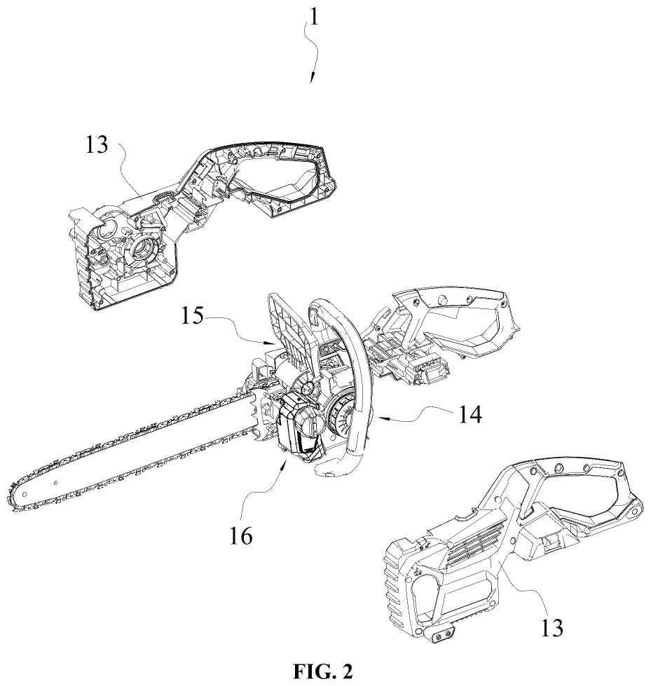

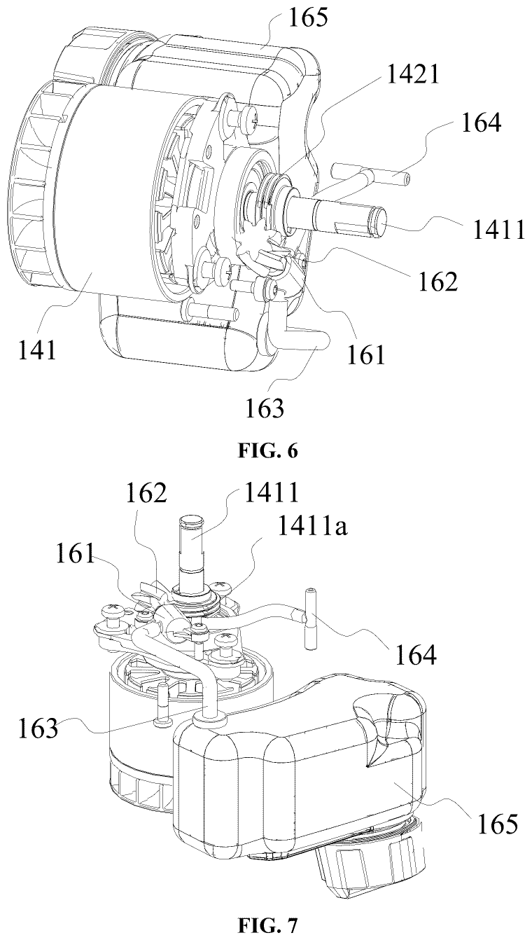

As shown in FIGS. 1 and 2, the tool body 1 includes a guide plate 11, a chain 12, a housing 13, a drive device 14, a brake device 15, and a lubrication device 16. The housing 13 is detachably connected to the battery pack 21. One end of the guide plate 11 is supported on the housing 13, and the other end of the guide plate 11 extends out of the housing 13 along the longitudinal direction of the housing 13. The guide plate 11 supports and guides the chain 12. The drive device 14 is disposed in an accommodating space formed by the housing 13 and includes a motor 141 (see FIG. 6). The power supply device 2 powers the motor 141 so that the motor 141 drives the chain 12 to rotate under the guide of the guide plate 11 to perform a cutting function. The brake device 15 can control the chain 12 to stop rotating so as to stop cutting work. The lubrication device 16 is configured to provide lubricant for the chain 12 or the guide plate 11.

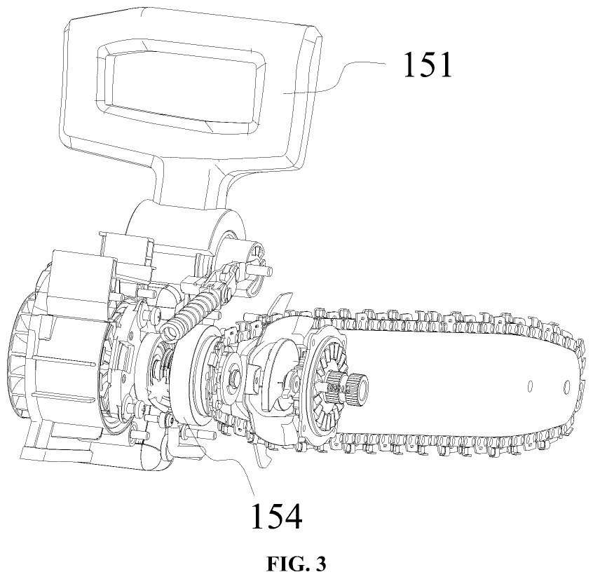

As shown in FIGS. 3 to 5, the motor 141 includes an output shaft 1411. The torque of the motor 141 is outputted through the output shaft 1411 so that the chain 12 is driven to rotate under the guide of the guide plate 11. The brake device 15 includes a brake trigger 151, an elastic member 152, a brake belt 153, and a brake disc 154. The brake trigger 151 partially protrudes from the accommodating space formed by the housing 13, and the elastic member 152, the brake belt 153, and the brake disc 154 are disposed in the accommodating space formed by the housing 13. The elastic member 152 may be a tension spring. The brake disc 154 is disposed on the output shaft 1411. Optionally, the brake disc 154 is circular, and a through hole is formed in the center of the brake disc 154. The output shaft 1411 can pass through the through hole and drive the brake disc 154 to rotate together. The brake belt 153 is disposed on the periphery of the brake disc 154. When the user needs to implement braking, the user may pull the brake trigger 151. The brake trigger 151 drives the elastic member 152 to contract and drive the brake belt 153 to rapidly contract and deform in a radial direction. The brake belt 153 instantly holds the brake disc 154 tight, and the brake disc 154 brakes the output shaft 1411 through friction while being held tight by the brake belt 153 for braking, thereby implementing a braking function. In this embodiment, the brake belt 153 contracts and deforms in the radial direction, which means that the free end of the brake belt 153 is pulled or released, causing the radius of a crimped region (that is, the region surrounding the brake disc 154) to become smaller or larger.

As shown in FIGS. 6 and 7, the lubrication device 16 includes an oil pump 161, a drive gear 162, an oil inlet pipe 163, an oil outlet pipe 164, and an oil can 165. The output shaft 1411 includes a worm portion 1411a. When the motor 141 rotates, the worm portion 1411a drives the drive gear 162 disposed on the oil pump 161 to rotate. When the drive gear 162 rotates, the internal volume of the oil pump 161 is changed such that an oil absorption action or an oil discharge action is performed. That is, the lubricant stored in the oil can 165 enters the oil pump 161 through the oil inlet pipe 163 and is pumped to the guide plate 11 through the oil outlet pipe 164 to lubricate the chain 12. An oil supply mode of the oil pump 161 may be continuous oil supply, intermittent oil supply, or a combination of continuous oil supply and intermittent oil supply. In an example, the capacity of the oil can 165 is greater than or equal to 100 milliliters and less than or equal to 600 milliliters. In an example, the volume of the oil can 165 is not greater than the volume of the motor 141, or the volume of the oil can 165 is less than or equal to 2.5 times the volume of the motor 141.

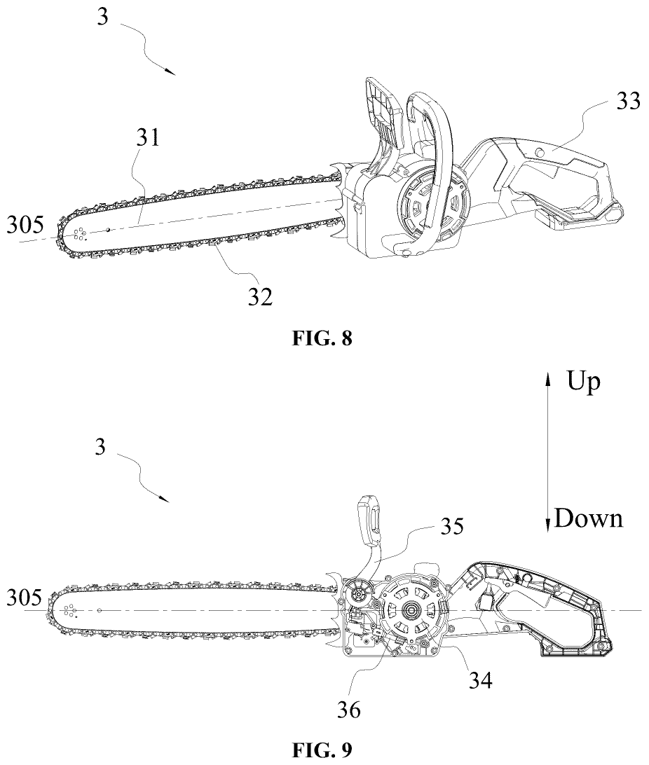

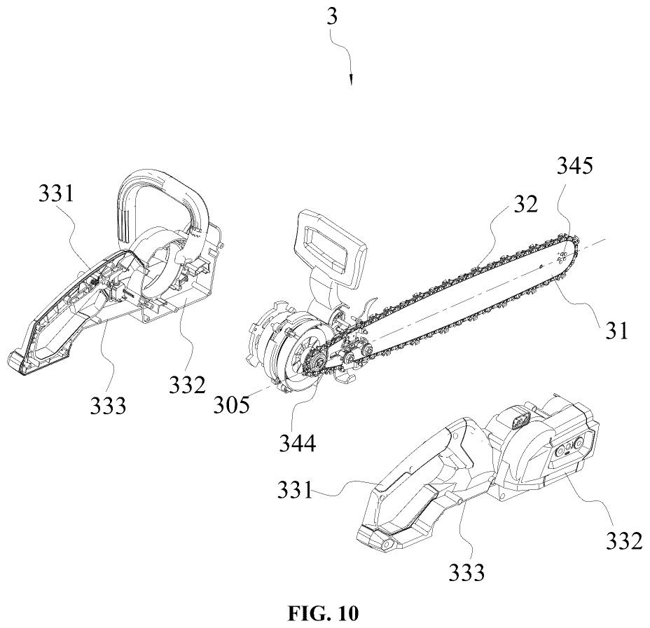

As shown in FIGS. 8 to 22, the present application further provides a tool body 3 having a higher output power density. For ease of description, components of the tool body 3 that are the same as or similar to those of the tool body 1 use the same or similar reference numerals, and differences from the tool body 1 in the preceding embodiment are mainly described in this embodiment. Portions in the preceding embodiment that are compatible with this embodiment may be applied to this embodiment. The power supply device 2 can be coupled to the tool body 3 and can power the tool body 3.

In some examples, the power supply device 2 may include different types of battery packs 21, for example, lithium batteries or sodium-ion batteries, battery packs with different nominal voltages, square batteries and cylindrical batteries, or pouch cells. The tool body 3 is configured to have a battery pack interface capable of receiving power from the different types of battery packs 21 described above.

As shown in FIGS. 8 to 10, the tool body 3 includes a guide plate 31, a chain 32, a housing 33, a drive device 34, a brake device 35, and a lubrication device 36. The drive device 34 includes a motor 341. The motor 341 can use a first straight line 301 as a rotation axis to drive an output shaft 3411 to rotate together. Optionally, the motor 341 is a brushless motor, and optionally, the motor 341 may be an outrunner. The housing 33 includes a handle portion 331 and a body portion 332. The handle portion 332 is configured to be held by the user. The body portion 332 is configured to accommodate the drive device 34, the lubrication device 36, and part of the brake device 35. The housing 33 further includes a coupling portion 333 configured to be coupled to the battery pack 21. In an example, the coupling portion 333 can receive power from different types of battery packs 21. In an example, the housing 33 includes two or more coupling portions 333 to simultaneously receive power from multiple battery packs 21. In other examples, the coupling portion 33 may be coupled to an adapter or a converter in addition to the battery pack 21.

In some examples, the plane on which the guide plate 31 is located is used as a cutting plane, and in a projection plane perpendicular to the cutting plane, the center of gravity of an orthographic projection of the tool body 3 is within an orthographic projection of the body portion 332 so that the overall balance of the tool body 3 is achieved.

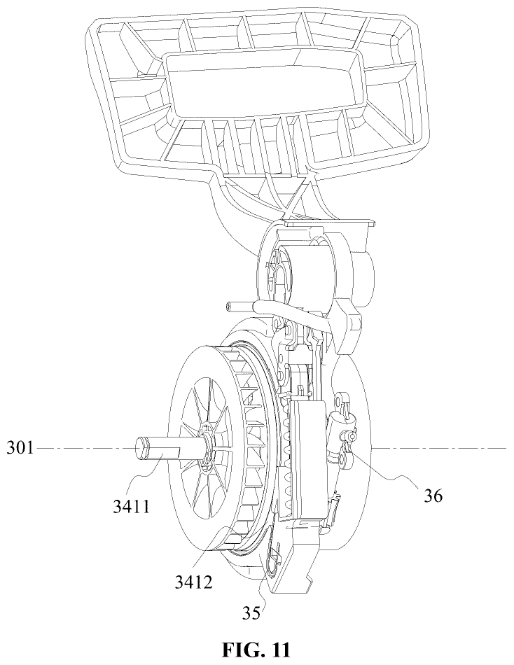

As shown in FIG. 11, this embodiment provides an example, and in this example, to reduce the volume and weight of the brake device 35 and the lubrication device 36, the brake device 35 and/or the lubrication device 36 can be integrated on the housing of the motor 341.

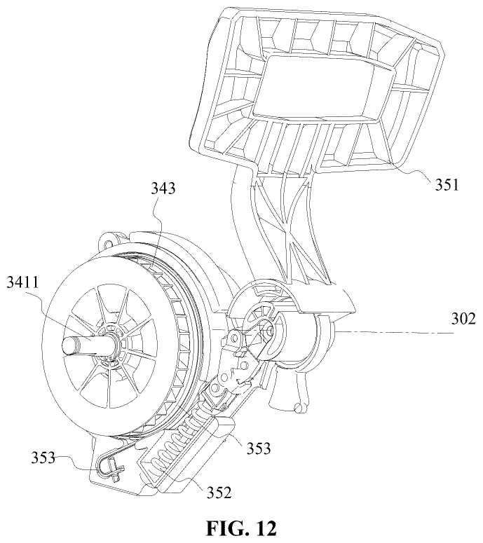

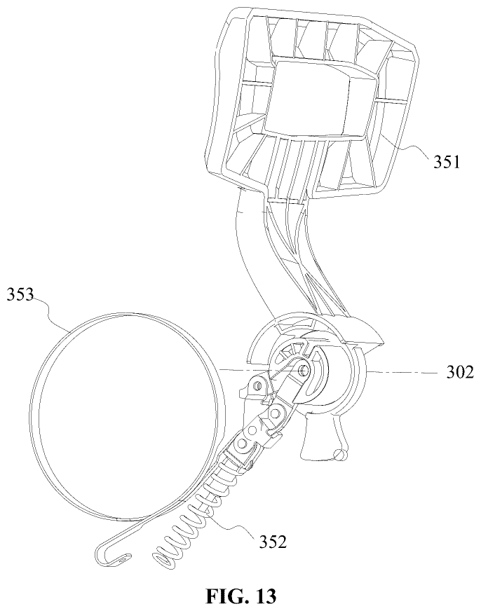

As shown in FIGS. 12 and 13, in some examples, the brake device 35 includes a brake trigger 351, an elastic member 352, and a brake belt 353. The brake trigger 351 is rotatable about a second straight line 302. The brake belt 353 is configured to surround at least part of a rotating drum 3412. In the case where the user needs to implement braking, the brake trigger 351 is pulled. The brake trigger 351 drives the elastic member 352 to contract and drive the brake belt 353 to rapidly contract and deform in a radial direction. The brake belt 353 instantly holds the rotating drum 3412 tight, and the rotating drum 3412 also brakes the motor 341 while being held tight by the brake belt 353 for braking, thereby implementing the mechanical braking function of the brake device 35. In the process where the mechanical braking function of the brake belt 353 is implemented, a free end of the brake belt 353 is pulled to deform itself and perform contraction motion toward the rotating drum 3412 at the same time. The brake belt 353 approaches and contacts the rotating drum 3412 during the contraction motion, and the surface area of the rotating drum 3412 surrounded and contacted by the brake belt 353 increases as the brake belt 353 contracts inward. In some examples, when the braking function is implemented, the wrap angle between the brake belt 353 and the rotating drum 3412 is greater than or equal to 10° and less than or equal to 360°. In some examples, when the braking function is implemented, the wrap angle between the brake belt 353 and the rotating drum 3412 is greater than or equal to 90°. In some examples, when the braking function is implemented, the wrap angle between the brake belt 353 and the rotating drum 3412 is greater than or equal to 180°. In some examples, when the braking function is implemented, the wrap angle between the brake belt 353 and the rotating drum 3412 is greater than or equal to 270°. Optionally, when the braking function is implemented, the wrap angle between the brake belt 353 and the rotating drum 3412 may be 270°, 315°, or 360°. The preceding wrap angle between the brake belt 353 and the rotating drum 3412 is the central angle corresponding to the contact arc between the brake belt 353 and the rotating drum 3412 when the braking function is implemented. In the case where no brake disc is provided, the brake belt and the degree of the central angle are configured such that the contact area between the brake device and the rotating drum is ensured. Thus, the braking function of the chainsaw can be implemented rapidly and effectively.

In this example, the tool body 3 is provided with no brake disc. Instead, the rotating drum 3412 is used as an object held tight by the brake belt 353. Compared with the tool body 1, the advantage of this technical solution is that the volume and weight of the brake device 36 can be reduced and the volumetric power density and the gravimetric power density of the tool body 3 can be increased. For example, if no brake disc is sleeved on the output shaft 3411, the length of the output shaft 3411 can be reduced. Thus, the length of the tool body 3 in the axial direction of the output shaft 3411 can be reduced, thereby enabling the volume of the tool body 3 to be reduced. In addition, since the brake disc is no longer provided, the weight of the brake device 35 and the weight of the tool body 3 are reduced. Of course, in other examples, for safety, a “dual brake system” may be adopted, where a first brake belt holds the brake disc tight, and a second brake belt holds the rotating drum tight. In other examples, the brake device 35 and the rotating drum 3412 may adopt shoe braking or caliper braking.

In some examples, in addition to the preceding mechanical brake module for mechanically braking the motor 341 through the friction between the brake belt 353 and the rotating drum 3412, the brake device 35 further includes an electronic brake module capable of causing the motor to stop rotating or reduce a rotational speed. The tool body 3 includes a controller (not shown in the figure) capable of controlling the start and stop of the motor 341 and the rotational speed of the motor 341. When the user pulls the brake trigger 351, the controller controls the motor 341 to stop rotating or reduce the rotational speed. In an example, after the user pulls the brake trigger 351, the controller first activates the electronic brake module to control the motor 341 to stop rotating or reduce the rotational speed, and then the brake belt 353 holds the rotating drum 3412 tight. In other examples, the brake device 34 may be configured to activate the mechanical brake module while the electronic brake module is activated or may be configured to activate the electronic brake module after the mechanical brake module is activated. In an example, the controller may include a circuit board through which an electronic braking function is implemented. In an example, a short circuit causes a current to increase instantly, and thus back electromotive force in the motor 341 is increased so that the motor 341 reduces the rotational speed or stops rotating. In this manner, the electronic braking function may be implemented.

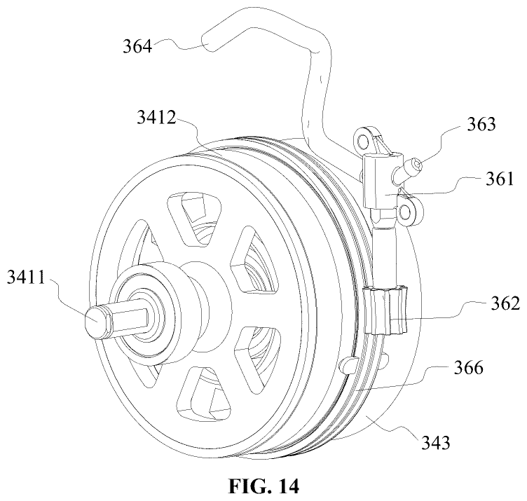

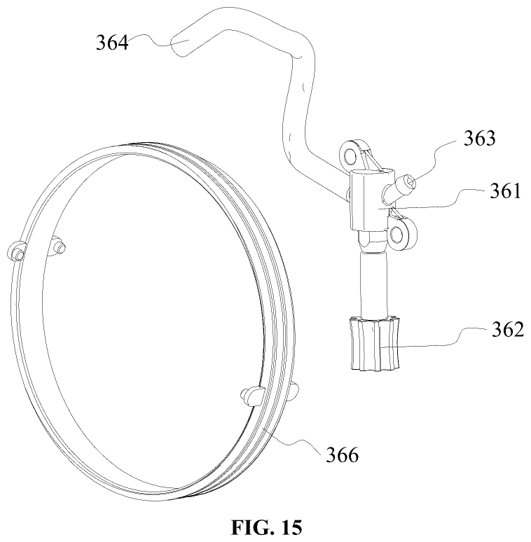

As shown in FIGS. 14 and 15, the present application further provides an example in which part of the lubrication device 36 is integrated on the rotating drum 3412, thereby increasing the volumetric power density of the tool body 3.

In some examples, the lubrication device 36 includes an oil pump 361, a drive gear 362, an oil inlet pipe 363, an oil outlet pipe 364, a gear sleeve 366, and an oil can (not shown in FIGS. 14 and 15). The gear sleeve 366 is sleeved on at least part of the rotating drum 3412, the gear sleeve 366 can mesh with the drive gear 362, and the drive gear 362 may be a worm wheel. When the motor 341 rotates, the motor 341 mounted with the gear sleeve 366 may be regarded as a worm, the gear sleeve 366 drives the drive gear 362 disposed on the oil pump 361 to rotate, and the rotating drive gear 362 drives the oil pump 361 to perform an oil absorption action or an oil discharge action, thereby implementing an oil pumping function.

Compared with the technical solution adopted by the tool body 1 that the worm portion 1411a of the output shaft 1411 meshes with the drive gear 162 to drive the oil pump 161 to pump oil, the drive gear 362 of the tool body 3 in this example is configured to be capable of being driven by the gear sleeve 366 sleeved on the rotating drum 3412 to rotate, and the length of the output shaft 3411 of the tool body 3 in the axial direction can be reduced due to the elimination of the worm portion. Thus, the volume of the tool body 3 can be reduced, and the volume power density of the tool body 3 is further increased.

In addition to the gear transmission provided in this example, in other examples, a transmission mode between the oil pump 361 and the motor 341 may be cam transmission or crank-link transmission.

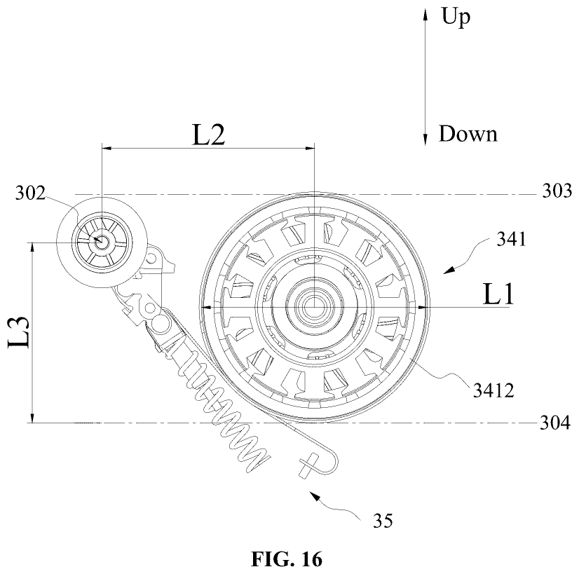

As shown in FIG. 16, the present application further provides an example, which can increase the volumetric power density of the tool body 3. In a plane perpendicular to the second straight line 302, a projection of the motor 341 is circular. The tangent line at the highest point of the rotating drum 3412 in an upward direction is a third straight line 303, and the tangent line at the lowest point of the rotating drum 3412 in a downward direction is a fourth straight line 304. A projection of the second straight line 302 is configured to be between the third straight line 303 and the fourth straight line 304. In an example, the first straight line 301 is parallel to the second straight line 302. In an example, for an accurate definition of an up and down direction, referring to FIGS. 8 to 10, a connecting line between the rotation axis of a drive sprocket 344 and the rotation axis of a driven sprocket 345 is used as a fifth straight line 305, and the up and down direction is perpendicular to the fifth straight line 305 in the plane perpendicular to the second straight line 302.

The diameter of a circular projection of the motor 341 is L1. Optionally, L1 ranges from 30 millimeters to 200 millimeters. In an example, the outer diameter of the motor 341 may be 30 millimeters, 65 millimeters, 90 millimeters, or 105 millimeters. In an example, the outer diameter of the motor 341 refers to the outer diameter of the rotor, and a fixing base is not included. In an example, the distance between the projection of the second straight line 302 and the center of the circular projection of the motor 341 is L2, and the ratio of L1 to L2 is higher than or equal to 0.25 and lower than or equal to 2. In an example, the minimum distance between the second straight line 302 and the fourth straight line 304 is L3, and L3 is greater than or equal to the radius of the circular projection of the motor 341. Optionally, L3 is greater than or equal to half of L1 and less than or equal to L1.

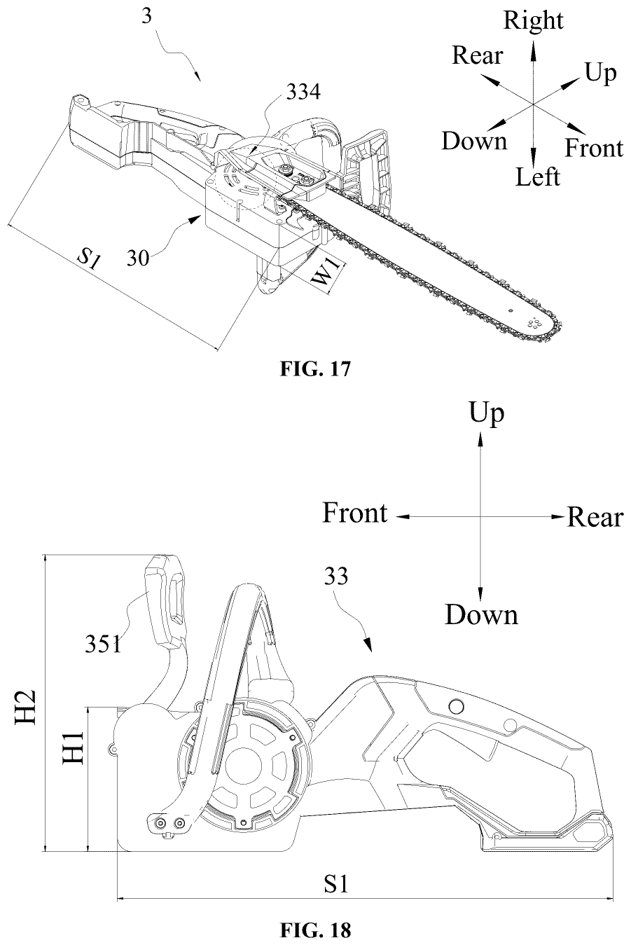

As shown in FIGS. 17 and 18, the present application further provides an example, where the length of the housing 33 of the tool body 3 in a front and rear direction is S1, the height of the housing 33 in the up and down direction is H1, the width of the housing 33 in a left and right direction is W1, and in the up and down direction, the height difference between the highest point of the brake trigger 351 and the lowest point of the housing is H2. In an example, S1>W1, H2>H1, and S1>H2.

In some examples, the output power of the chainsaw 100 is greater than or equal to 4000 W, that is, the output power of the motor 341 is greater than or equal to 4000 W. In this example, the chainsaw 100 with an output power of greater than or equal to 4000 W can provide a great cutting strength for the user, thereby adapting to various working scenarios.

In some examples, the rotational speed of the motor 341 is greater than or equal to 5000 rpm. In an example, the rotational speed of the motor 341 is greater than or equal to 5000 rpm and less than or equal to 20000 rpm, and optionally, the rotational speed of the motor 341 is greater than or equal to 7000 rpm and less than or equal to 18000 rpm.

In some examples, the drive device 34 further includes a transmission assembly (not shown in the figure) configured to transmit the torque of the motor 341 to the chain 32. In an example, the tool body 3 can adjust an output rotational speed of the transmission assembly by changing the gear ratio of the transmission assembly or the rotational speed of the motor 341.

In some examples, the rated linear speed of the chain 32 of the tool body 3 is greater than or equal to 10 m/s and less than or equal to 70 m/s. Optionally, the rated linear speed of the chain 32 may be greater than or equal to 13 m/s and less than or equal to 30 m/s, or the rated linear speed of the chain 32 may be approximately equal to 60 m/s.

In some examples, except the guide plate 31 and the chain 32, the housing 33, the drive device 34, the brake device 35, and the lubrication device 36 together constitute a main machine 30 of the tool body 3. The mass of the main machine 30 is the mass of the tool body 3 with the guide plate 31 and the chain 32 removed. In some examples, the center of gravity of an orthographic projection of the main machine 30 is within the orthographic projection of the body portion 332 on the projection plane perpendicular to the cutting plane, so as to conform to ergonomic design and achieve the overall balance of the tool body 3.

In some examples, the power-to-mass density of the main machine 30 is greater than or equal to 0.5 kW/kg and less than or equal to 2.0 kW/kg. Optionally, the power-to-mass density of the main machine 30 may be 0.5 kW/kg, 0.6 kW/kg, 0.68 kW/kg, 0.75 kW/kg, 1.1 kW/kg, 1.18 kW/kg, 1.3 kW/kg, 1.34 kW/kg, 1.35 kW/kg, 1.4 kW/kg, 1.49 kW/kg, 1.5 kW/kg, 1.6 kW/kg, or 1.8 kW/kg.

In some examples, the power of the motor 341 is 4 kW, and the mass of the main machine 30 is greater than or equal to 3.0 kg and less than or equal to 3.5 kg. Optionally, the mass may be 3.0 kg, 3.2 kg, 3.29 kg, 3.3 kg, 3.39 kg, 3.4 kg, 3.49 kg, or 3.5 kg.

In some examples, the power of the motor 341 is 5 kW, and the mass of the main machine 30 is greater than or equal to 3.5 kg and less than or equal to 4.0 kg. Specifically, the mass may be 3.5 kg, 3.6 kg, 3.61 kg, 3.7 kg, 3.71 kg, 3.75 kg, 3.8 kg, 3.81 kg, 3.85 kg, 3.9 kg, or 4.0 kg.

In some examples, the power of the motor 341 is 6 kW, and the mass of the main machine 30 is greater than or equal to 3.9 kg and less than or equal to 4.5 kg. Optionally, the mass may be 3.9 kg, 3.94 kg, 4.0 kg, 4.1 kg, 4.14 kg, 4.15 kg, 4.2 kg, 4.3 kg, 4.4 kg, or 4.5 kg.

In some examples, the power-to-mass density of the tool body 3 (including the guide plate 31 and the chain 32) is greater than or equal to 0.2 kW/kg and less than or equal to 2.0 kW/kg. Optionally, the power-to-mass density of the tool body 3 may be 0.6 kW/kg, 0.8 kW/kg, 1.5 kW/kg, or 2.0 kW/kg.

In some examples, the total energy of the power supply device 2 is greater than or equal to 20 Wh. In an example, the nominal voltage of the power supply device 2 is greater than or equal to 25 V and less than or equal to 150 V. Optionally, the nominal voltage of the power supply device 2 may be greater than or equal to 30 V and less than or equal to 120 V.

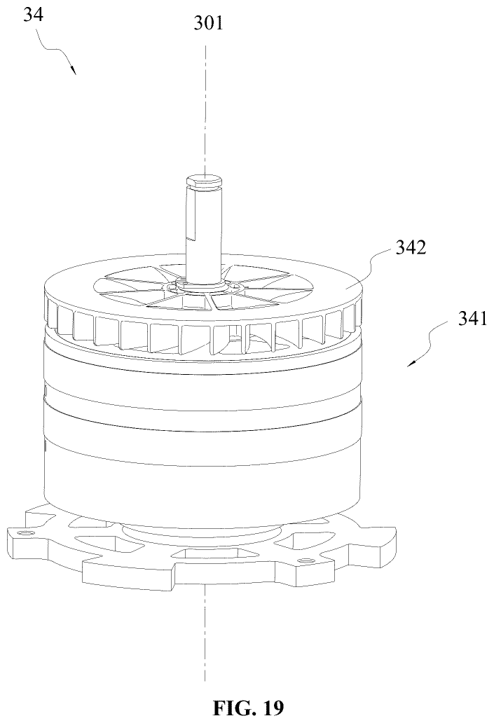

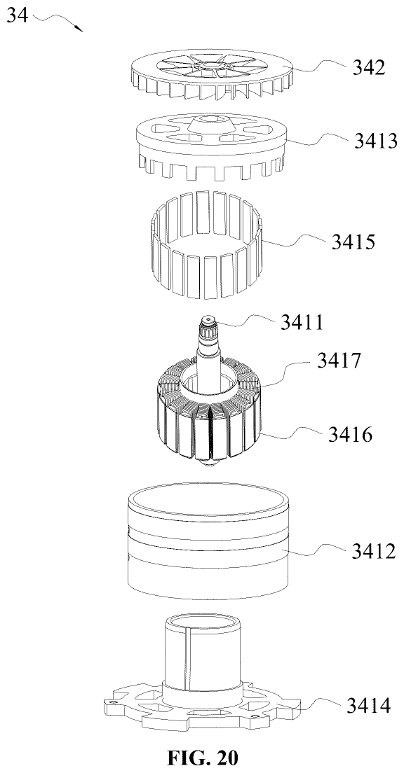

As shown in FIGS. 19 and 20, this embodiment further provides an example, and in this example, the motor 341 is an outrunner and includes the output shaft 3411, the rotating drum 3412, an end cover 3413, a mounting base 3414, magnets 3415, a stator core 3416, and winding coils 3417. The rotor of the motor 341 includes the output shaft 3411 and the rotating drum 3412. The output shaft 3411 is configured to output the torque of the motor 341. The rotating drum 3412 is also referred to as a sleeve or a yoke and is configured to accommodate components such as the winding coils 3417 and the magnets 3415. The end cover 3413 is disposed at an end portion of the rotating drum 3412 and used for preventing the components such as the magnets 3415 from being separated from the rotating drum 3412 along the axial direction of the motor 341 (that is, the direction of the first straight line 301). The mounting base 3414 is configured to be mounted with the rotating drum 3412. The winding coils 3417 are wound around the stator core 3416. The stator core 3416 is typically made of metal such as steel or iron, and the stator core is also referred to as a stator iron core. The stator core 3416 includes multiple individual stator laminations (not shown in the figure) that are stacked together to form the stator core 3416. The winding coils 3417 are configured to be coils wound onto the stator core 3416, and the winding coils are also referred to as windings. The stator core 3416 is provided with connecting arms for winding the winding coils 3417, and a gap is provided between adjacent connecting arms. The winding coils 3417 are wound onto the connecting arms and are at least partially located in gaps.

In some examples, the mounting base 3414 and the end cover 3413 are disposed at two ends of the rotating drum 3412, respectively and jointly prevent the components such as the magnets 3415 from being separated from the rotating drum 3412 along the axial direction of the motor 341. In an example, the end cover 3413 or the mounting base 3414 or the rotating drum 3412 includes an aluminum alloy material to enhance the heat dissipation capability of the drive device 34.

The drive device 34 further includes a fan 342. The fan 342 is mounted at an end of the end cover 3413 or the mounting base 3414 far from the rotating drum 3412. The fan 342 can generate an airflow, and the airflow can carry away heat when passing the motor 341.

The drive device 34 further includes a circuit board 343. Power elements are disposed on the circuit board 343, generate a large amount of heat in operation, and require heat dissipation. However, in some examples, the motor 341 and the circuit board 343 are separated from each other in terms of position. A wire connection is required between the motor 341 and the circuit board 343 to transmit an electrical signal. A wire and the circuit board 343 need to be fixed on other parts of the tool body 3 to occupy part of the volume in the inner cavity of the housing 33. The motor 341 also needs to dissipate heat in operation. Therefore, if the motor 341 and the circuit board 343 are separated from each other in terms of position, multiple heat dissipation air paths need to be designed and a relatively large volume is occupied, which is not conducive to the lightness of the tool body 3 and further affects the heat dissipation capability of the drive device 34.

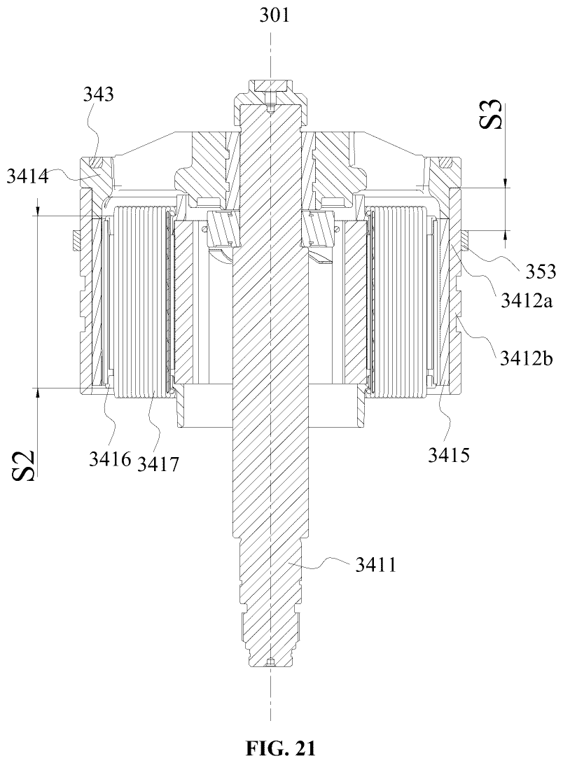

In some examples, the circuit board 343 is configured to be integrated with the motor 341. Optionally, the circuit board 343 is mounted on the end cover 3413 or the mounting base 3414, and the circuit board 343 has an annular structure. For example, the circuit board 343 is fixed to the end cover 3413 or the mounting base 3414 through a screw or an adhesive. Alternatively, the end cover 3413 or the mounting base 3414 is provided with a mounting groove, the circuit board 343 is mounted in the mounting groove (see FIG. 21), and the circuit board 343 is in interference fit with the end cover 3413 or the mounting base 3414. In this example, the circuit board 343 is integrated with the motor 341, which saves the space occupied by the circuit board 343 and wires and facilitates the lightweight design of the tool body 3. In addition, the heat dissipation air path can simultaneously pass the circuit board 343 and the motor 341, thereby improving the heat dissipation efficiency. The circuit board 343 includes a power module and a control module. In this example, the circuit board 343 containing the power module is configured to be mounted in the mounting groove of the end cover 3413 or the mounting base 3414.

In some examples, the tool body 3 further includes a temperature sensor (not shown in the figure) configured to monitor a temperature of the motor 341 or a temperature of the circuit board 343. In the case where the temperature of the motor 341 or the temperature of the circuit board 343 is higher than a preset threshold, the controller controls the motor 341 to reduce the rotational speed or stop rotating.

In some examples, the power-to-mass density of the drive device 34 is greater than or equal to 2.5 kW/kg and less than or equal to 3.5 kW/kg. Optionally, the power-to-mass density of the drive device 34 may be 2.5 kW/kg, 2.8 kW/kg, 2.9 kW/kg, 3.0 kW/kg, 3.1 kW/kg, 3.2 kW/kg, 3.3 kW/kg, or 3.4 kW/kg.

As shown in FIG. 21, in some examples, the rotating drum 3412 includes a brake portion 3412a and a mounting portion 3412b. The brake portion 3412a is configured to be held tight by the brake belt 353 for braking. The mounting portion 3412b is configured to be mounted with the gear sleeve 366. To meet the braking requirement, the Rockwell hardness difference between the brake belt 353 and the brake portion 3412a is at most 10 HRC or 30 HRC. The housing material of the brake portion 3412a may include a metal material with high wear resistance, such as alloy steel. The brake belt 353 may have a Rockwell hardness of 40 HRC to 55 HRC, and the brake portion 3412a may have a Rockwell hardness of 58 HRC to 68 HRC. In an example, the ratio of the hardness of the brake belt 353 to the hardness of the brake portion 3412a may be higher than or equal to 59% and lower than or equal to 95%.

The brake belt 353 is mounted on the brake portion 3412a. Therefore, in an example, to balance the force applied to the motor 341, the length of the stator core 3416 along the direction of the first straight line 301 is S2, and the minimum distance between the brake belt 353 and the fixing end for the output shaft 3411 in the direction of the first straight line 301 is S3, where S3≤S2*(½).

When the chain 32 cuts a target object, debris is generated. Part of the debris rotates along with the guide plate 31 and the chain 32, accumulating in the housing below the chain 32. When too much debris accumulates, the cutting performance of the tool body 3 may be affected.

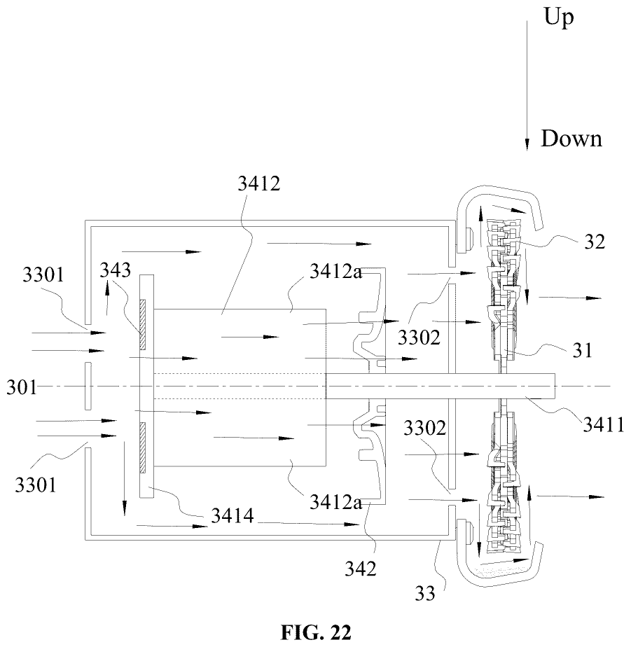

As shown in FIG. 22, to solve the problem of debris accumulation, the present application further provides an example, where the fan 342 is disposed at an end of the output shaft 3411 extending out of the rotating drum 3412 to output torque, the guide plate 31 and the chain 32 are disposed at the end of the output shaft 3411 extending out of the rotating drum 3412, one end of the rotating drum 3412 is used for allowing the output shaft 3411 to extend out, and the mounting base 3414 is mounted at the other end of the rotating drum 3412, that is, the rotating drum 3412 is located between the mounting base 3414 and the fan 342. In this example, a heat dissipation airflow generated by the rotating fan 342 passes through the motor 341 and the fan 342 sequentially and then can pass the guide plate 31 and the chain 32. The airflow blows the debris accumulated below the chain 32 out of the housing 33 while carrying away the heat of the guide plate 31 and the heat of the chain 32. The heat dissipation airflow can pass through the inside of the motor 341 and can simultaneously pass the brake portion 3412a to carry away heat generated by the motor 341 when operating and braking. In other examples, the mounting base 3414 may be disposed between the rotating drum 3412 and the fan 342.

In an example, the housing 33 includes an air inlet 3301 and an air outlet 3302. The air inlet 3301 is oriented toward or close to part of the mounting base 3414, and the air outlet 3302 is oriented toward or close to part of the guide plate 31 and part of the chain 32. Optionally, the power module of the circuit board 343 is mounted at an end of the mounting base 3414 oriented toward or close to the air inlet 3301. The airflow generated by the rotating fan 342 can also carry away heat generated by the power module when the circuit board 343 operates. To improve the heat dissipation capability, the rotating drum 3412 and/or the mounting base 3414 may be made of an aluminum-based material. In other examples, the circuit board 343 may not be mounted on the mounting base 3414, and the air inlet 3301 is configured to be oriented toward the power module of the circuit board 343.

In an example, the debris has a relatively high probability of accumulating in a debris accumulation region 334 (see FIG. 17) of the housing 33, and the heat dissipation airflow can pass the debris accumulation region 334 to blow the debris out of the housing 33.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A chainsaw, comprising:
a main machine comprising a housing, a drive device at least partially disposed in an accommodating space formed by the housing and comprising a motor, and a brake device configured to brake the drive device;
a guide plate attachable to the main machine;
a chain configured to perform a cutting function driven by the drive device and supported and guided by the guide plate; and
a power supply device couplable to the main machine configured to provide a power source for the drive device;
wherein the motor is an outrunner, and a ratio of output power of the main machine to a mass of the main machine is higher than or equal to 0.5 kW/kg and lower than or equal to 2.0 kW/kg.

2. The chainsaw according to claim 1, wherein the output power of the motor is 4 kW, and the mass of the main machine is greater than or equal to 3.0 kg and less than or equal to 3.5 kg, or the output power of the motor is 5 kW, and the mass of the main machine is greater than or equal to 3.5 kg and less than or equal to 4.0 kg, or the output power of the motor is 6 kW, and the mass of the main machine is greater than or equal to 3.9 kg and less than or equal to 4.5 kg.

3. The chainsaw according to claim 1, wherein a ratio of output power of the motor to a mass of the motor is higher than or equal to 1 kW/kg and lower than or equal to 5 kW/kg.

4. The chainsaw according to claim 1, wherein a rotational speed of the motor is greater than or equal to 5000 rpm and less than or equal to 20000 rpm.

5. The chainsaw according to claim 1, wherein a rated linear speed of the chain is greater than or equal to 10 m/s and less than or equal to 70 m/s.

6. The chainsaw according to claim 1, wherein a nominal voltage of the power supply device is greater than or equal to 25 V and less than or equal to 150 V.

7. The chainsaw according to claim 1, wherein the power supply device comprises a plurality of battery packs with different nominal voltages.

8. The chainsaw according to claim 1, wherein the housing comprises a handle portion configured to be held by a user and a body portion at least configured to accommodate the drive device and a part of the brake device, a plane on which the guide plate is located is used as a cutting plane, and, in a projection plane perpendicular to the cutting plane, a center of gravity of an orthographic projection of the main machine is within an orthographic projection of the body portion.

9. The chainsaw according to claim 1, wherein the brake device comprises a mechanical brake module capable of mechanically braking the motor through friction and an electronic brake module capable of causing the motor to stop rotating or reduce a rotational speed, the brake device is configured to: activate the mechanical brake module after the electronic brake module is activated, or activate the mechanical brake module while the electronic brake module is activated, or activate the electronic brake module after the mechanical brake module is activated.

10. The chainsaw according to claim 1, wherein the motor is a brushless motor.

11. The chainsaw according to claim 10, wherein an outer diameter of the outrunner is greater than or equal to 30 millimeters and less than or equal to 200 millimeters.

12. The chainsaw according to claim 1, wherein the motor comprises an output shaft configured to output torque of the motor and a rotating drum capable of accommodating part of the output shaft, the drive device further comprises a fan disposed at an end of the output shaft extending out of the rotating drum to output the torque, the fan is disposed between the guide plate and the rotating drum, and an airflow generated by the rotating fan is capable of passing the guide plate and/or the chain.

13. The chainsaw according to claim 12, wherein the housing comprises a debris accumulation region, and the airflow generated by the rotating fan is capable of passing the debris accumulation region.

14. The chainsaw according to claim 1, further comprising a lubrication device comprising an oil pump capable of pumping lubricant to the guide plate or the chain, wherein, when the motor rotates, the oil pump is capable of being driven by the rotating drum of the rotating motor to work.

15. The chainsaw according to claim 1, wherein the motor comprises a rotating drum and a mounting base mounted at an end of the rotating drum, the drive device further comprises a circuit board capable of controlling at least a start and a stop operation of the motor, and the circuit board is mounted on the mounting base.

16. A chainsaw, comprising:
a housing;
a chain configured to perform a cutting function;
a guide plate for supporting and guiding the chain;
a drive device at least partially disposed in an accommodating space formed by the housing and comprising a motor rotatable about a first straight line and configured to drive the chain;
a brake device configured to brake the motor; and
a power supply device configured to provide a power source for the drive device;
wherein the motor is an outrunner, a ratio of output power of the motor to a mass of the motor is higher than or equal to 1 kW/kg and lower than or equal to 5 kW/kg, the motor comprises a rotating drum and the rotating drum is capable of being configured to cooperate with the brake device to implement mechanical braking, the brake device comprises a brake belt surrounding at least part of the rotating drum, and the brake belt is configured to be capable of performing contraction motion on a surface of the rotating drum to mechanically brake the motor.

17. The chainsaw according to claim 16, wherein a wrap angle formed between the brake belt and the rotating drum when the mechanical braking is implemented is greater than or equal to 10° and less than or equal to 360°.

18. The chainsaw according to claim 16, wherein the brake device comprises a brake trigger configured to be pulled by a user to activate a braking function, and the brake trigger is rotatable about a second straight line, wherein in a plane perpendicular to the second straight line, a tangent line at a highest point of a circular projection of the motor in an up and down direction is a third straight line, a tangent line at a lowest point of the circular projection of the motor in the up and down direction is a fourth straight line, and a projection of the second straight line is between the third straight line and the fourth straight line.

19. The chainsaw according to claim 18, wherein, in the plane perpendicular to the second straight line, a distance between the projection of the second straight line and a center of the circular projection of the motor is L2, wherein a ratio of L1 to L2 is higher than or equal to 0.25 and lower than or equal to 2.

20. A chainsaw, comprising:
a housing;
a chain configured to perform a cutting function;
a guide plate for supporting and guiding the chain;
a drive device at least partially disposed in an accommodating space formed by the housing and comprising a motor rotatable about a first straight line and configured to drive the chain;
a brake device configured to brake the drive device;
a power supply device configured to provide a power source for the drive device;
wherein the motor is an outrunner, and output power of the motor is greater than or equal to 4000 W.
